(19) United States
(12) Patent Application Publication
(10) Pub. No.: US 2004/0221314 A1
(43) Pub. Date: Nov. 4, 2004

(54) Addressable tap with status collect and verification functions used in CATV networks

(76) Inventors: Yung-Liang Chang, KaoHsiung City (TW); Chih-chou Shih, Taichung City (TW)

Correspondence Address: Judson K. Champlin, Westman, Champlin & Kelly, Suite 1600, 900 Second Avenue South, Minneapolis, MN, 55402-3319, US

(21) Appl. No.: 10/827,592

(22) Filed: Apr. 19, 2004

(30) Foreign Application Priority Data
Apr. 29, 2003 (CN) 03225811.9

(51) Int. Cl. H04N 7/16; H04N 7/173

(52) U.S. Cl. 725/118; 725/127; 725/120; 725/145

(57) ABSTRACT

An ADTap status collect, verification device that can be used in CATV addressable taps is featured by: a fed-back signal monitor located at the front of addressable tap and a fed-back signal detector; Said monitor consists of a receiving circuit, a CPU and radio frequency (RF) transmitting circuit. Said receiving circuit and radio frequency (RF) transmitting circuit are electrically connected with the CPU separately; Said detector consists of radio frequency (RF) receiving circuit, CPU and displaying circuit; said radio frequency (RF) receiving circuit and displaying circuit are electrically connected to CPU; Said monitor and detector are linked for communications. Compared with the existing technology, the present invention has the following effects: by way of supervising the cutting-off status of RF switches of the addressable taps capable of payment collection management, full management on payment collection can be realized. It is easy in management at low management costs.

### FIELD OF INVENTION

This invention is directed to the image communication technological sector, especially a device in supervising status of addressable tap used in CATV in cutting off CATV signal for fee collection management.

### BACKGROUND OF THE INVENTION

Addressable taps capable of payment collection management can cut off CATV signals through RF switches in many cases, such as fees due unpaid. As the current CATV networks do not have two-way transmission function, it is impossible to supervise actual status at the end of CATV networks. If it is necessary to know the cutting-off status of RF switches in the addressable taps capable of payment collection management, a two-way transmission system can be established in CATV networks to realize it, or by presence in person to check in users' house. The first method requires upgrade networking at high costs; the second method is time- and labor-consuming and inconvenient in management.

### BRIEF SUMMERY OF THE INVENTION

Technical problems that the current invention aims to solve is avoiding the disadvantages in the existing technology by way of a collect, verification device capable of supervising the RF switch cutting-off status of addressable taps, by which supervision is convenient at low costs.

The technical problems that this invention aims at can be solved by the following technical plan:

Design and use an Addressable Tap collect, verification device that can be used in CATV, which shall consist of a feed-back signal monitor and a feed-back signal detector; said monitor consists of receiving circuit, CPU and radio frequency (RF) transmitting circuit. Said receiving circuit and radio frequency (RF) transmitting circuit are electrically connected to CPU; said detector consists of radio frequency (RF) receiving circuit, CPU and displaying circuit. Said radio frequency circuit and displaying circuit are electrically connected to the CPU and said monitor and detector are connected to communicate.

Compared with the existing technology, the present invention has the following effects: by way of supervising the cutting-off status of RF switches of the addressable taps capable of payment collection management, full management on payment collection can be realized without the need to be present in person at users' house to check whether the taps are working normally or not, nor is HFC (Hybrid Fiber Coaxial) full two way system needed. It is easy in management at low management costs.

### BRIEF DESCRIPTION OF THE DRAWINGS

FIG. 1 is a sketch of working principles of the feed-back signal verification device of the current invention Addressable Tap;

FIG. 2 is a function block diagram of the fed-back signal monitor in said fed-back verification device;

FIG. 3 is a function block diagram of said fed-back verification detector.

### PREFERRED EMBODIMENT

Further introduction is made in combination with the attached drawings.

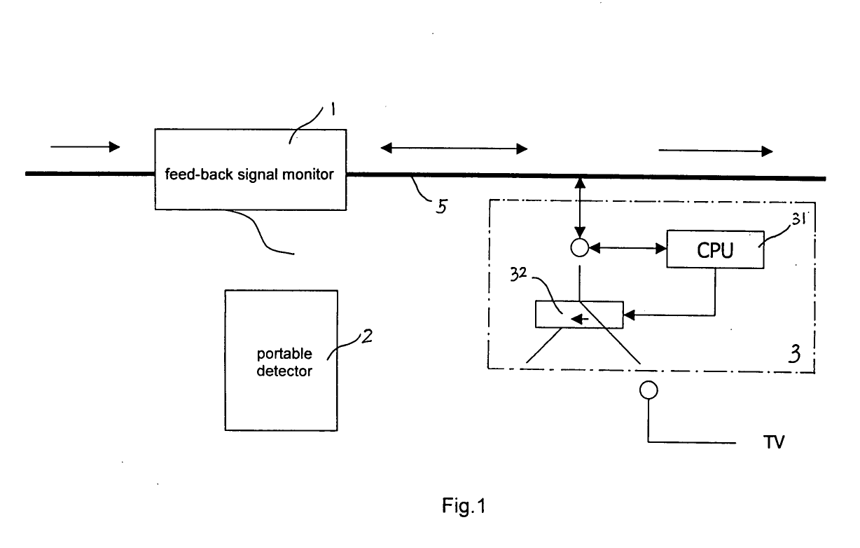

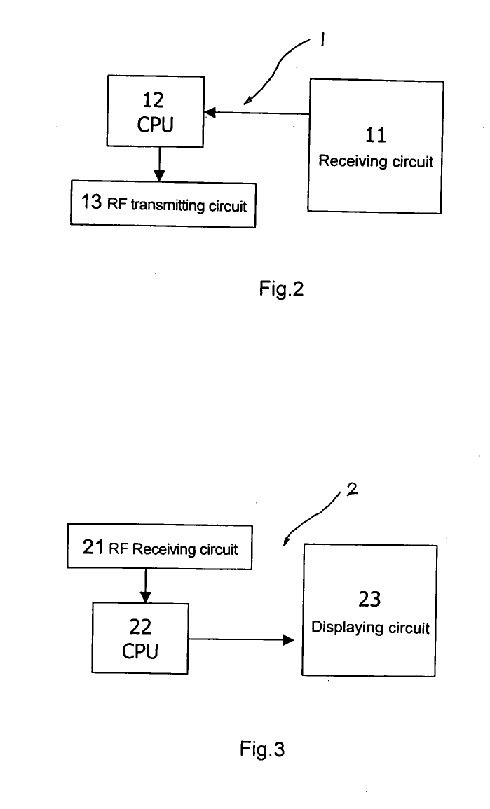

A feed-back cutting-off signal verification device that can be used in addressable taps in CATV networks as shown in FIG. 1 consists of feed-back signal monitor 1 located at the front of the addressable tap 3 and movable feed-back signal detector 2; as shown in FIG. 2, said monitor 1 consists of a receiving circuit 11, a CPU and a radio frequency (RF) transmitting circuit 13. Said receiving circuit 12 and radio frequency (RF) transmitting circuit 13 are electrically connected to CPU 11; said movable detector 2 consists of a radio frequency (RF) receiving circuit 21, a CPU22 and a displaying circuit 23. Said radio frequency (RF) receiving circuit and displaying circuit 23 are electrically connected to CPU22 separately; said monitor 1 and detector 2 are connected for communication.

As shown in FIG. 1, the addressable tap 3 comprises of a CPU31 and RF switches 32. Said addressable tap 3 has input AC voltage of 60V and control signals at 110 MHz as well as CATV signals from the main cable 5. The filter and demodulation module (not shown in the figure) in said addressable tap 3 demodulates the control signals in the input signals and transmits them to CPU31 inside said addressable tap 3. After receiving the control signals, CPU 31 can control over the RF switches 32. CATV signals and control signals inside the input signals are transmitted to the RF switches 32. Each of RF switches corresponds to a terminal to a user.

As shown in FIG. 1 to FIG. 3, after frequency-shift key-controlled modulation, the CPU 31 in the addressable tap 3 transmits cutting-off signals of the RF switches under its control to said monitor 1 located at the front of all the addressable taps in an area, a building or a community. The receiving circuit 11 of said monitor 1 receives said feed-back cutting-off signals and then transmits them to the CPU 12, which will transmit out the feed-back cutting-off signals through said radio frequency (RF) transmitting circuit 13 after receiving said fed-back cutting-off signals. While detecting on-off status of the terminal switches of the addressable tap 3, engineers will carry the portable defective device 2 to the transmitting range of said monitor 1 and the radio frequency (RF) receiving circuit 21 will receive fed-back cutting-off signals transmitted by monitor land then transmit them to CPU22. Then, they are displayed on the screen of the displaying circuit 23. In this way, engineers outside the users' house can detect the working status of addressable taps.

In order to make sure that the power of CATV network can support all the addressable taps 3, said monitor 1 could be equipped with a power supply module that is electrically connected to CPU12. In case that power of CATV network is not enough to supply all the addressable taps 3, such power supply module will provide power to the downstream addressable taps below said monitor 1. Said monitor 1 could be also equipped with an amplification module to make sure signals amplified for use by all the user terminals in case of weak signals.

What is claimed is:

1. An ADTap status collect, verification device that can be used in CATV addressable taps is featured by: a fed-back signal monitor located at the front of addressable tap and a fed-back signal detector;
Said monitor consists of a receiving circuit, a CPU and radio frequency (RF) transmitting circuit. Said receiving circuit and radio frequency (RF) transmitting circuit are electrically connected with the CPU separately;
Said detector consists of radio frequency (RF) receiving circuit, CPU and displaying circuit; said radio frequency (RF) receiving circuit and displaying circuit are electrically connected to CPU;
Said monitor and detector are linked for communications, Said monitor receives the fed-back cutting-off signals from said addressable tap and transmits out the fed-back cutting-off signals. Within transmitting range of said monitor, said detector receives fed-back cutting-off signals by the monitor.

2. An ADTap collect, verification device that can be used in CATV addressable taps as defined in claim 1 is featured by: said detector is movable.

3. An ADTap collect, verification device that can be used in CATV addressable taps as defined in claim 1 is featured by: said monitor also includes a power supply module, which is electrically connected with said CPU.

4. An ADTap collect, verification device that can be used in CATV addressable taps as defined in claim 1 is featured by: said monitor also includes an amplification module, which is electrically connected to said CPU.
